(19) United States
(12) Patent Application Publication
(10) Pub. No.: US 2009/0305837 A1
(43) Pub. Date: Dec. 10, 2009

(54) PLANETARY GEAR TYPE MULTI-STAGE TRANSMISSION

(76) Inventor: Kazuyoshi HIRAIWA, Yokohama (JP)

Correspondence Address: WENDEROTH, LIND & PONACK, L.L.P., 1030 15th Street, N.W.,, Suite 400 East, Washington, DC, 20005-1503, US

(21) Appl. No.: 12/479,156

(22) Filed: Jun. 5, 2009

(30) Foreign Application Priority Data
Jun. 9, 2008 (JP) 2008-150203
Nov. 26, 2008 (JP) 2008-300296

(51) Int. Cl. F16H 3/62

(52) U.S. Cl. 475/275; 475/271

(57) ABSTRACT

A multi-stage transmission includes a first planetary gear set, a second planetary gear set, a first reduction planetary gear set, a second reduction gear set, a clutch for locking the second planetary gear set. The first reduction planetary gear set has an input member, an output member and a holding member. The input shaft is connected with the first carrier, being connectable with the input member and the second ring gear that are connected with each other. The output shaft is connected or connectable with the second carrier, being connectable with the output member through the second reduction gear set. The first sun gear and the holding member are connected with each other, being holdable to a stationary part. The first ring gear is connected or connectable with the second sun gear.

### BACKGROUND OF THE INVENTION

1. Field of the Invention

The present invention relates to a planetary gear type multi-stage transmission, adapted for motor vehicles, which can obtain forward multi-gears.

2. Description of the Related Art

Planetary gear type multi-stage transmissions with forward first to eighth gears are realized to improve a fuel consumption ratio, exhaust characteristics, acceleration performance and others. Such a conventional planetary gear type multi-stage transmission is disclosed in Japanese Patent NO. 3777929. This conventional transmission includes one double-pinion type planetary gear set and a Ravigneaux type planetary gear set, equipping with six friction elements such as clutches and brakes, where the friction elements are shifted so that two elements thereof are always engaged during running of the transmission.

However, in the above known conventional planetary gear type multi-stage transmission, there are problems in that it needs two double-pinion type planetary gear sets (namely the one double-pinion type planetary gear set and another one included in the Ravigneaux type planetary gear set), consequently its manufacturing costs becoming higher compared with a single-pinion type planetary gear transmission, and the double-pinion type planetary gear sets degrading power transmission efficiency thereof because of many engagements of gears. In addition, four friction elements of the six ones are always idling during the operation of the transmission, so that drag torque due to the idling friction elements becomes larger. Consequently, the fuel consumption ratio of the motor vehicle becomes worse, and much exothermic heat generates in the conventional transmission.

It is, therefore, an object of the present invention to provide a planetary gear type multi-stage transmission which overcomes the foregoing drawbacks and can decrease the number of the double-pinion type planetary gear sets and also decrease the number of friction elements that idle during the operation of the transmission, thereby improving power transmission efficiency and decreasing exothermic heat generated in the transmission.

### SUMMARY OF THE INVENTION

According to a first aspect of the present invention there is provided a planetary gear type multi-stage transmission including an input shaft, an output shaft, a first planetary gear set, a second planetary gear set, a first reduction planetary gear set, a second reduction gear set, a stationary part, and a clutch. The first planetary gear set is arranged in co-axial with the input shaft, and it has a first sun gear, a first ring gear, a plurality of first pinions that engage with the first sun gear and the first ring gear, and a first carrier rotatably supporting the first pinions. The second planetary gear set has a second sun gear, a second ring gear, a plurality of second pinions that engage with the second sun gear and the second ring gear, and a second carrier rotatably supporting the second pinions. The first reduction planetary gear set has an input member, an output member, and a holding member. The clutch is capable of locking the second planetary gear set so that the second planetary gear set rotates as one unit. The input shaft is connected with the first carrier, being connectable with the input member and the second ring gear that are connected with each other. The output shaft and the second carrier are in one of a connected state and a connectable state. The output shaft is connectable with the output member through the second reduction gear set. The first sun gear and the holding member are connected with each other, and the first sun gear and the holding member are holdable to the stationary part. The first ring gear and the second sun gear are in one of a connected state and a connectable state.

Therefore, the planetary gear type multi-stage transmission of the present invention can decrease the number of the double-pinion type planetary gear sets and also decrease the number of friction elements that idle during the operation of the transmission, thereby improving power transmission efficiency and decreasing exothermic heat in the transmission.

### BRIEF DESCRIPTION OF THE DRAWINGS

The objects, features and advantages of the present invention will become apparent as the description proceeds when taken in conjunction with the accompanying drawings, in which:

FIG. 1 is a diagram showing a power train of a planetary gear type multi-stage transmission of a first embodiment according to the present invention;

FIG. 2 is an operation table of friction elements of the planetary gear type multi-stage transmission of the first embodiment;

FIG. 3 is a diagram showing a power train of a planetary gear type multi-stage transmission of a second embodiment according to the present invention;

FIG. 4 is a diagram showing a power train of a planetary gear type multi-stage transmission of a third embodiment according to the present invention;

FIG. 5 is a diagram showing a power train of a planetary gear type multi-stage transmission of a fourth embodiment according to the present invention;

FIG. 6 is an operation table of friction elements of the planetary gear type multi-stage transmission of the fourth embodiment; and

FIG. 7 is a diagram showing a power train of a planetary gear type multi-stage transmission of a fifth embodiment according to the present invention.

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

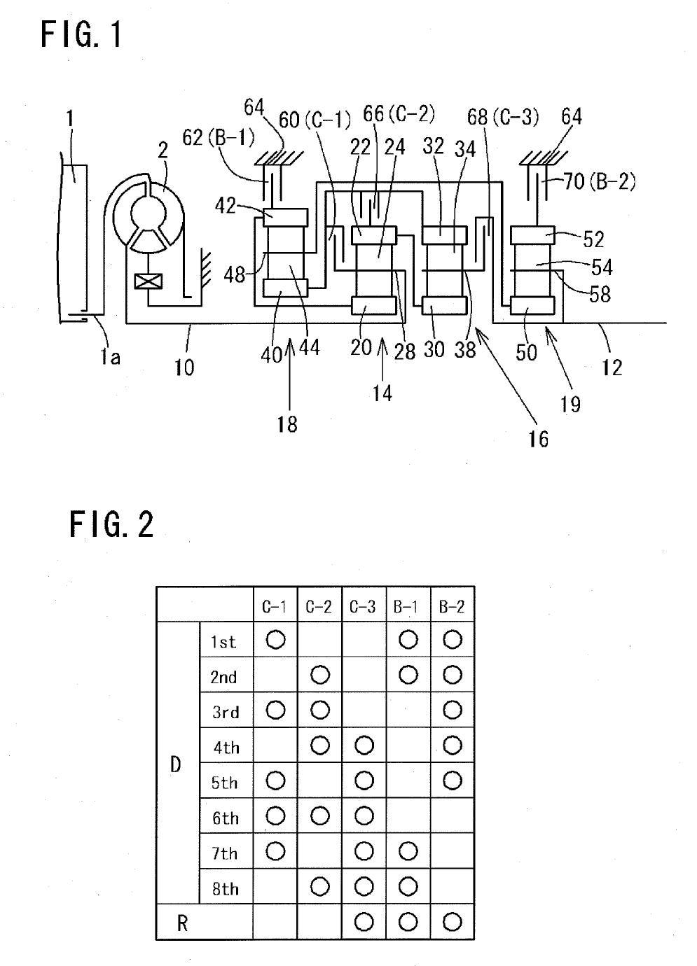

FIG. 1 schematically shows a power train of a planetary-gear type multi-stage transmission of a first preferred embodiment according to the present invention. FIG. 1 illustrates an upper half part of the multi-stage transmission with respect to an input shaft 10.

Referring to FIG. 1, the input shaft 10 of the multi-stage transmission is connected with a crank shaft 1a of an engine 1 through a torque converter 2 to receive engine torque. An output shaft 12 of the multi-stage transmission outputs output torque of the transmission to not-shown drive wheels. The input shaft 10 and the output shaft 12 are arranged in co-axial with the crank shaft 1a.

The multi-stage transmission has a first planetary gear set 14, a secondary planetary gear set 16, a third planetary gear set 18 and a fourth planetary gear set 19, between the input shaft 10 and the output shaft 12. Each of the first to fourth planetary gear sets is constructed as a single-pinion type planetary gear set, consisting of rotation members similar to one another.

The first planetary gear set 14 consists of the rotation members: a first sun gear 20, a first ring gear 22, a plurality of first pinions 24 that each engages with the first sun gear 20 and the first ring gear 22, and a first carrier 28 that rotatably supports the first pinions 24.

The second planetary gear set 16 consists of the rotation members: a second sun gear 30, a second ring gear 32, a plurality of second pinions 34 that each engages with the second sun gear 30 and the second ring gear 32, and a second carrier 38 that rotatably supports the second pinions 34.

The third planetary gear set 18 consists of the rotation members: a third sun gear 40, a third ring gear 42, a plurality of third pinions 44 that each engages with the third sun gear 40 and the third ring gear 42, and a third carrier 48 that rotatably supports the third pinions 44.

The fourth planetary gear set 19 similarly consists of the rotation members: a fourth sun gear 50, a fourth ring gear 52, a plurality of fourth pinions 54 that each engages with the fourth sun gear 50 and the fourth ring gear 52, and a fourth carrier 58 that rotatably supports the fourth pinions 54.

Between the torque converter 2 and the output shaft 12, the third planetary gear set 18, the first planetary gear set 14, the second planetary gear set 16 and the fourth planetary gear set 19 are arranged in that order from an upstream side of the transmission toward a downstream side thereof, so that the transmission is suitable for front-engine rear-drive cars.

The input shaft 10, the output shaft 12, and the rotation members of the first to fourth planetary gear sets 14, 16, 18 and 19 are mechanically connected or connectable as follows.

The input shaft 10 is always connected with the first carrier 28 and is also connectable with the second ring gear 32 and the third sun gear 40 by engagement of a first clutch 60, where the second ring gear 32 and the third sun gear 40 are always connected with each other.

The first sun gear 20 is always connected with the third ring gear 41 and is holdable against rotation to a case 64, corresponding to a stationary part, of the transmission, functioning as a stationary portion, by engagement of a first brake 62.

The first ring gear 22 is always connected with the second sun gear 30 and is connectable with the second ring gear 32 and the third sun gear 40 through a second clutch 66, where the second ring gear 32 and the third sun gear 40 are always connected with each other. Engagement of the second clutch 66 causes the second sun gear 30 and the second ring gear 32 to be connected with each other, which locks the second planetary gear set 16 so that the rotation members thereof cannot rotate relative therebetween, consequently the second planetary gear set 16 rotating as one unit.

The third carrier 48 is always connected with the fourth sun gear 50. The fourth ring gear 52 is holdable against rotation to the case 64 by engagement of a second brake 70.

The output shaft 12 is always connected with the fourth carrier 58 and is connectable with the second carrier 38 through a third clutch 68.

The third planetary gear set 18 acts as a first reduction planetary gear set of the present invention, where the third sun gear 40 acts as an input member of the present invention, the third carrier 48 acts as an output member of the present invention, and the third ring gear 42 acts as a holding member of the present invention.

On the other hand, the fourth planetary gear set 19 acts as a second reduction gear set of the present invention. Engagement of the second brake 70 holds the fourth ring gear 52 against rotation to the case 64, which results in that input to the fourth sun gear 50 is decreased in speed to be outputted to the output shaft 12.

Incidentally, the first clutch 60, the second clutch 66, the third clutch 68, the first brake 62 and the second brake 70 are friction elements. In this embodiment, the first clutch 60, the second clutch 66 and the third clutch 68 are multiple-friction-disc driving clutches that are operated by pressurized oil, while the first brake 62 and the second brake 70 are multiple-friction-disc holding clutches (namely brakes) or band-brakes that are operated by pressurized oil.

Next, the operation of the friction elements will be described with reference to FIG. 2.

FIG. 2 shows an operation table explaining which friction elements are applied or released to establish the first to eighth and reverse gears. The multi-stage transmission can provide “P (=Parking)” position, “R (=Reverse)” position, “N (=Neutral)” position, “D (Drive)” position and “L (=Low)” position, but the operation table shows only “D” position and “R” position.

In the operation table, an engagement state of each friction element is indicated by a mark “∘”, while a disengagement state thereof is indicated by a blank.

Herein, a teeth ratio of each planetary gear set is defined by an equation (the number of teeth of a sun gear)/(the number of teeth of a ring gear) and is expressed by α(=Zs/Zr). The teeth ratio of the first planetary gear set 14 is expressed as α1, the teeth ratio of the second planetary gear set 16 is expressed as α2, the teeth ratio of the third planetary gear set 18 is expressed as α3, and the teeth ratio of the fourth planetary gear set 19 is expressed as α4.

For example, in this embodiment, the teeth ratio α1 is set to be 0.60, the teeth ratio α2 is set to be 0.60, the teeth ratio α3 is set to be 0.60, and the teeth ratio α4 is set to be 0.55.

A speed ratio of the transmission is defined a ratio of the rotational speed of the input shaft 10 to the rotational speed of the output shaft 12.

The following equations use “A” in order to simplify the equations, where A=α1·α1(1+α3)/(1+α2). Incidentally, A=0.360 when the teeth ratios of the planetary gear sets are set to have numeric values set above.

In order to obtain the forward first gear, the first clutch 60 (C-1), the first brake 62 (B-1), and the second brake 70 (B-2) are engaged. Incidentally, the second brake 70 is maintained in the engagement state from the forward first gear to the forward fifth gear.

Then the speed ratio at the forward first gear becomes to be (1+α3)(1+α4)/(α3-α4), consequently being 7.515 under the above-set numerical values of the teeth ratios of the planetary gear sets.

In order to shift from the first gear to the forward second gear, the first clutch 60 is released, and the second clutch 66 (C-2) is engaged.

Then the speed ratio at the forward second gear becomes to be (1+α3)(1+α4)/{α3·α4(1+α1)}, consequently being 4.697 under the above-set numerical values of the teeth ratios.

In order to shift from the second gear to the forward third gear, the first brake 62 is released, and the first clutch 60 is engaged again.

The speed ratio at the forward third gear becomes to be (1+α4)/α4, consequently being 2.818 under the above-set numerical values of the teeth ratios.

In order to shift from the third gear to the forward fourth gear, the first clutch 60 is released, and the third clutch 68 (C-3) is engaged.

The speed ratio at the forward fourth gear becomes to be {α4(1+α1)+α1(1+α3)}/{α4(1+α1)}, consequently being 2.091 under the above-set numerical values of the teeth ratios.

In order to shift from the fourth gear to the fifth gear, the second clutch 66 is released, and the first clutch 60 is engaged again.

The speed ratio at the forward fifth gear becomes {α4(1+A)+A}/{α4(1+A)}, consequently being 1.481 under the above-set numerical values of the teeth ratios.

In order to shift from the fifth gear to the forward sixth gear, the second brake 70 is released, and the second clutch 66 is engaged again. This operation causes the first and second planetary gear sets 14 and 16 to be locked so that the rotation members thereof cannot rotate relative therebetween, consequently the first and second planetary gear sets 14 and 16 rotating as one unit. The input shaft 10 is integrally connected with the output shaft 12 through the first and second planetary gear sets 14 and 16.

Accordingly, the speed ratio at the forward sixth gear becomes to be 1.000, namely a direct drive ratio, which is independent from the teeth ratios of the first to fourth planetary gear sets.

In order to shift from the sixth gear to the forward seventh gear, the second clutch 66 is released, and the first brake 62 is applied again.

The speed ratio at the forward seventh gear becomes to (1+α3)/(1+α3+A), consequently being 0.816, which is an overdrive ratio, under the above-set numerical values of the teeth ratios.

In order to shift from the seventh gear to the forward eighth gear, the first clutch 60 is released, and the second clutch 66 is engaged again.

The speed ratio at the forward eighth gear becomes 1/(1+α1), consequently being 0.625, which is also an overdrive speed ratio, under the above-set numerical values of the teeth ratios.

On the other hand, in order to obtain the reverse gear, the third clutch 68 and the second brake 70 are engaged.

The speed ratio at the reverse gear becomes to be (1+α2)/{α2(1+α1)}−(1+α3)(1+α4)/{α2·α3·α4(1+α1)}, consequently being −6.462 under the above-set numerical values of the teeth ratios, where “−” means a reverse rotational direction.

Then, the speed ratios at the first to eighth gears are arranged below, while the gear steps are shown in parentheses at the right side, where the gear step is defined as a ratio of the speed ratios of the neighboring gears: {the speed ratio of the (n-1)th gear}/{the speed ratio of the (n)th gear}, where “n” is integral numbers greater than zero.

| Gear | Speed Ratio | Gear Step |
|---|---|---|
| The first gear | 7.515 | (1.600) |
| The second gear | 4.697 | (1.667) |
| The third gear | 2.818 | (1.348) |
| The fourth gear | 2.091 | (1.412) |
| The fifth gear | 1.481 | (1.481) |
| The sixth gear | 1.000 | (1.225) |
| The seventh gear | 0.816 | (1.306) |
| The eighth gear | 0.625 | |

These values show that the transmission of the first embodiment can provide the desirable eighth gears with the desirable gear steps. The transmission of the first embodiment is suitable especially for heavy trucks and busses.

As described above, the planetary gear type multi-stage transmission of the first embodiment has the following advantages.

It can provide the desirable speed ratios of the forward eighth and reverse gears. In addition, the first to fourth planetary gear sets 14, 16, 18 and 19 are single-pinion type ones, which have simple structures in light weight, also having high power transmission efficiency. Further, the number of the friction elements that are always idled during operation of the transmission is reduced to only two, which means that the transmission of the first embodiment can decrease two idling friction elements compared to that of the prior art. Therefore, the transmission of the first embodiment can improve a fuel consumption ratio, suppressing exothermic heat generation due to drag torque of the idling friction elements.

Next, a planetary gear type multi-stage transmission of a second embodiment according to the present invention will be described with reference to the accompanying drawing.

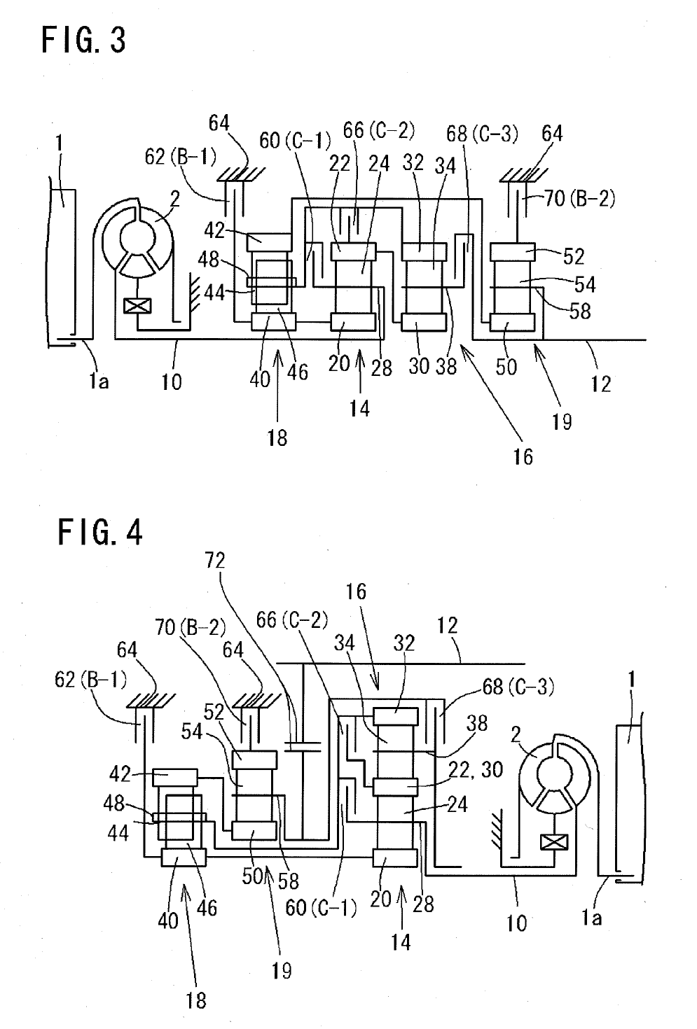

FIG. 3 schematically shows the multi-stage planetary gear transmission of the second embodiment. FIG. 3 illustrates an upper half part of the multi-stage transmission with respect to an input shaft 10.

The multi-stage planetary gear transmission of the second embodiment uses only one double-pinion type planetary gear set instead of the single-pinion type planetary gear set acting as the third planetary gear set 18 (the first reduction planetary gear set) of the first embodiment.

Specifically, the third planetary gear set 18 of the second embodiment has a third sun gear 40, a third ring gear 40, a plurality of third outer pinions 44 that engage with the third ring gear 42, a plurality of third inner pinion 46 that engage with the third outer pinions 44 and the third sun gear 40, and a third carrier 48 that rotatably supports the third outer pinions 44 and the inner pinions 46.

The third carrier 48 acts as the input member of the present invention, the third sun gear 40 acts as the holding member of the present invention, and the third ring gear 42 acts as the output member of the present invention.

The other parts and portions of the transmission of the second embodiment are constructed similarly to those of the second embodiment. In addition, the transmission of the second embodiment is operated similarly to that of the first embodiment, according to the operation table shown in FIG. 2.

The speed ratios of the transmission of the second embodiment are changed as follows from those of the first embodiment, because of using the double-pinion type planetary gear set as the third planetary gear set 18.

| Gear | Speed Ratio |
|---|---|
| The first gear | (1 + α4)/{α4(1 − α3)} |
| The second gear | (1 + α4)/{α4(1 + α1)(1 − α3)} |
| The third gear | (1 + α4)/α4 |
| The fourth gear | {α3 · α4(1 − α1) + α1}/{α3 · α4(1 + α1)} |
| The fifth gear | (α1 · α2 + B)/B |
| The sixth gear | 1.000 |
| The seventh gear | (1 + α2)/(1 + α2 + α1 · α2) |
| The eighth gear | 1/(1 + α1) |
| Reverse gear | (1 + α2)/{α2(1 + α1)} − (1 + α4)/{α2 · |
| | α4(1 + α1)(1 − α3)}, |

where B = α4{α3(1 + α2) + α1 · α2}.

For example, in the second embodiment, the teeth ratios of the first to fourth planetary gear sets 14, 16, 18 and 19 are set as follows: the teeth ratio α1 of the first planetary gear set 14 is set to be 0.410, the teeth ratio α2 of the second planetary gear set 16 is set to be 0.626, the teeth ratio α3 of the third planetary gear set 18 is set to be 0.460, and the teeth ratio α4 of the fourth planetary gear set 19 is set to be 0.545.

Then the speed ratios and the gear steps are obtained as follows. Incidentally, B=0.548.

| Gear | Speed Ratio | Gear Step |
|---|---|---|
| The first gear | 5.250 | (1.410) |
| The second gear | 3.723 | (1.313) |
| The third gear | 2.835 | (1.313) |
| The fourth gear | 2.160 | (1.471) |
| The fifth gear | 1.469 | (1.469) |
| The sixth gear | 1.000 | (1.158) |
| The seventh gear | 0.864 | (1.219) |
| The eighth gear | 0.709 | |
| Reverse gear | −4.105 | |

These values show that the transmission of the second embodiment can provide the desirable forward first to eighth and reverse gears with the desirable gear steps. The transmission of the second embodiment is suitable for passenger vehicles.

As described above, the planetary gear type multi-stage transmission of the second embodiment has the following advantages.

It can provide the desirable speed ratios of the forward eighth and reverse gears. In addition, the first, second and fourth planetary gear sets 14, 16 and 19 are single-pinion type ones, which have simple structures in light weight, also having high power transmission efficiency, while the double-pinion type planetary gear set is suppressed only to one set, namely the third planetary gear set 18. Further, the number of the friction elements that are always idled during operation of the transmission is reduced to only two, which means that the transmission of the second embodiment can decrease two idling friction elements compared to that of the prior art. Therefore, the transmission of the first embodiment can improve fuel consumption, suppressing exothermic heat generation due to drag torque of the idling friction elements.

Next, a planetary gear type multi-stage transmission of a third embodiment according to the present invention will be described with reference to the accompanying drawing.

FIG. 4 schematically shows the multi-stage planetary gear transmission of the third embodiment. In FIG. 4, an upper half part of an input-shaft 10 side of the multi-stage transmission is illustrated with respect to an input shaft 10, and a lower half part of an output-shaft 12 side is illustrated with respect to an output shaft 12.

The multi-stage planetary gear transmission of the third embodiment is suitable for front-engine front-wheel drive vehicles. It uses one double-pinion-type planetary gear set, two planetary gear sets are stacked in a radial direction, and the input shaft 10 and the output shaft 12 are arranged in parallel to each other.

Specifically, the third planetary gear set 18 of the first embodiment is changed to the double pinion type planetary gear set similarly to the second embodiment, and a second planetary gear set 16 is overlapped with a first planetary gear set 14, being stacked in a radially outer side of the first planetary gear set 14. A first ring gear 22 and a second sun gear 30 are formed as one unit. A fourth carrier 58 and a second carrier 38 are connected with the output shaft 10 through a connecting gear set 72.

The other parts/portions are constructed similarly to those of the first embodiment and the second embodiment.

The multi-stage planetary gear transmission of the third embodiment is operated according to the operation table shown in FIG. 2. Accordingly, an explanation as to the operation is omitted.

Thus, the connecting gear set 72 is provided between the fourth carrier 58 and the output shaft 12, so that the speed ratios are obtained only by multiplying the speed ratios of the second embodiment by a teeth ratio of the connecting gear set 72, although the teeth ratio of the connecting gear set 72 affects the speed ratios of the multi-stage transmission. Accordingly, the values of the speed ratios of the third embodiment are omitted.

As described above, the multi-stage planetary gear transmission of the third embodiment has the following advantages.

It can provide the desirable forward first to eighth gears with the desirable gear steps, being suitable for passenger cars, similarly to the second embodiment. It uses only one double-pinion type planetary gear set, the rest being a single-pinion type planetary gear set, so that it becomes simpler in structure, light in weight, and high in power transmission efficiency. The number of the friction elements that are always idling is two, being less by two than that of the prior art. This can decrease drag resistance due to the idling friction elements. Therefore, the multi-stage transmission of the third embodiment can improve its fuel consumption, suppressing exothermic heat generation.

In addition, it can decrease its axial length because the second planetary gear set 16 is arranged at the radially outer side of the first planetary gear set 14. It is suitable for the front-engine front-wheel drive cars.

Next, a planetary gear type multi-stage transmission of a fourth embodiment according to the present invention will be described with reference to the accompanying drawings.

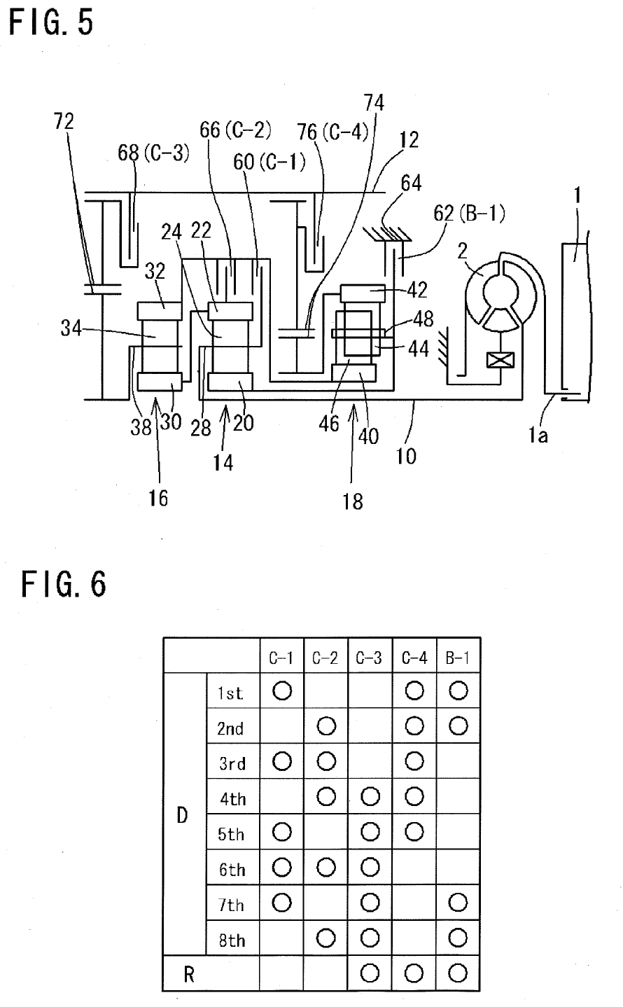

FIG. 5 schematically shows the multi-stage planetary gear transmission of the fourth embodiment. In FIG. 5, an upper half part of an input-shaft 10 side of the multi-stage transmission is illustrated with respect to an input shaft 10, and a lower half part of an output-shaft 12 side is illustrated with respect to an output shaft 12.

The multi-stage planetary gear transmission of the fourth embodiment is also suitable for front-engine front-wheel drive vehicles. It uses one double-pinion-type planetary gear set, and the input shaft 10 and the output shaft 12 are arranged in parallel to each other. In addition, a reduction gear set 74 is used instead of the second reduction gear set 19 of the first embodiment and the third embodiment.

A first planetary gear set 14, a second planetary gear set 16 and a third planetary gear set 18 are arranged in series on the input shaft 10. The first planetary gear set 14 and the second planetary gear set 16 are single-pinion type ones, while only the third planetary gear set 18 is a double-pinion type one.

A third clutch 68 is arranged at an output shaft 12 side, and a fourth clutch 76 is also arranged at the output shaft 12 side and between the reduction gear set 74 and the output shaft 12. The fourth clutch 67 functions as the second brake 70 of the first embodiment. In other words, an engagement of the fourth clutch 76 causes a third ring gear 42 corresponding to an output member to be connected with the output shaft 12 through the reduction gear set 74.

The third planetary gear set 18 corresponding to the first reduction planetary gear set of the fourth embodiment are different in relationships of rotation members from the second embodiment and the third embodiment.

In the fourth embodiment, a third sun gear 40 acts as the input member, a third carrier 48 acts as the holding member, and a third ring gear 42 acts as the output member.

FIG. 6 is an operation table of the planetary gear type multi-stage transmission of the fourth embodiment. The difference between the operation table of the first embodiment and the operation table of the fourth embodiment is only that the fourth clutch 76 (C-4) of the fourth embodiment is substituted for the second brake 70 (B-2) of the first embodiment. Accordingly, the multi-stage transmission of the fourth embodiment can obtain forward eighth and reverse gears.

The speed ratios obtained by the multi-stage transmission of the fourth embodiment are as follows.

A teeth ratio is defined as (the number of an input shaft 10 side gear)/(the number of an output shaft 12 side gear). In the fourth embodiment, the teeth ratio of the connecting gear set 72 is set to be i1, and the teeth ratio of the reduction gear set 74 is set to be i2.

| Gear | Speed Ratio |
|---|---|
| The first gear | i2/α3 |
| The second gear | i2/{α3(1 + α1)} |
| The third gear | i2 |
| The fourth gear | α1 · i2/{(1 + α1)(1 − α3) + i1 · C} |
| The fifth gear | α1 · i2 · D/α3 + i1 · D(i1 + α2)/α2 |
| The sixth gear | i1 |
| The seventh gear | i1(1 + α2)/{1 + α2 (1 + α1)} |
| The eighth gear | i1/(1 + α1) |
| Reverse gear | i1(1 + α2)/{α2(1 + α1)} − i2/(1 + α4)/{α2 · |
| | α3(1 + α1)}, |

where C = 1/(1 + α1) − α1(1 − α3)/{α3(1 + α1)}, and
D = α2 · α3/{α3 + α2 · α3(1 + α1) + α1 · α2(1 − α3)}.

In the fourth embodiment, teeth ratios α1 to α3 of the first to third planetary gear sets are set to be 0.430, 0.626 and 0.490, respectively, and i1 is set to be 0.90 and i2 is set to be 1.98. The speed ratios of the forward first to eighth and reverse gears and the gear steps become as follows.

| Gear | Speed Ratio | Gear Step |
|---|---|---|
| The first gear | 4.041 | (1.430) |
| The second gear | 2.826 | (1.427) |
| The third gear | 1.980 | (1.307) |
| The fourth gear | 1.515 | (1.292) |
| The fifth gear | 1.173 | (1.303) |
| The sixth gear | 0.900 | (1.166) |
| The seventh gear | 0.772 | (1.227) |
| The eighth gear | 0.629 | |
| Reverse gear | −2.879 | |

These values show that the transmission of the fourth embodiment can provide the desirable speed ratios with the desirable gear steps. The transmission of the fourth embodiment is suitable for passenger cars.

As described above, the planetary gear type multi-stage transmission of the forth embodiment has the following advantages.

It can provide the desirable forward first to eighth gears with the desirable gear steps, being suitable for passenger cars, similarly to the second embodiment. It uses only one double-pinion type planetary gear set, the rest being a single-pinion type planetary gear set, so that it becomes simpler in structure, light in weight, and high in power transmission efficiency. The number of the friction elements that are always idling is two, being less by two than that of the prior art. This can decrease drag resistance due to the idling friction elements. Therefore, the multi-stage transmission of the fourth embodiment can improve its fuel consumption, suppressing exothermic heat generation.

Next, a planetary gear type multi-stage transmission of a fifth embodiment according to the present invention with reference to the accompanying drawing.

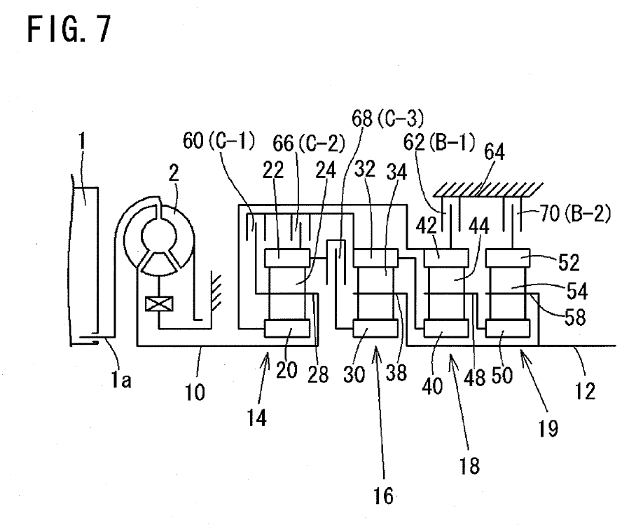

FIG. 7 schematically shows the multi-stage planetary gear transmission of the fifth embodiment. In FIG. 7, an upper half part of an input-shaft 10 side of the multi-stage transmission is illustrated with respect to an input shaft 10.

In the multi-stage planetary gear transmission of the fifth embodiment, the output shaft 12 is connected with a second carrier 38. A third clutch 68 is disposed between a first ring gear 22 and a second sun gear 30 so that the third clutch 68 can engage the first ring gear 22 and the second sun gear 30 with each other.

The order of arrangement of a first planetary gear set 14, a second planetary gear set 16, a third planetary gear set 18 and fourth planetary gear set 19 is different from those of the first to fourth embodiments, but rotation members of the planetary gear sets 14, 16, 18 and 19 are connected similarly to the first embodiment. Accordingly, the multi-stage transmission of the fifth embodiment is operated according to the operation table shown in FIG. 2.

As a result, the multi-stage transmission of the fifth embodiment can obtain the same speed ratios and gear steps as those of the first embodiment.

The multi-stage transmission of the fifth embodiment can obtain the following advantages.

It can provide the desirable forward first to eighth gears with the desirable gear steps, being suitable for passenger cars, similarly to the first embodiment. It uses only a single-pinion type planetary gear set, so that it becomes simpler in structure, light in weight, and high in power transmission efficiency. The number of the friction elements that are always idling is two, being less by two than that of the prior art. This can decrease drag resistance due to the idling friction elements. Therefore, the multi-stage transmission of the fifth embodiment can improve its fuel consumption, suppressing exothermic heat generation.

While there have been particularly shown and described with reference to preferred embodiments thereof, it will be understood that various modifications may be made therein, and it is intended to cover in the appended claims all such modifications as fall within the true spirit and scope of the invention.

For example, although the above-described embodiments use the torque converter, a fluid coupling or a friction clutch may be used between and the engine 1 and the input shaft 10 instead of the torque converter.

In addition, the arrangements of the planetary gear sets, the reduction gear sets and the friction elements, such as a clutch and a brake, may be appropriately changed according to a layout of a transmission.

The transmission according to the present invention is applicable to from small passenger cars to large commercial cars.

The entire contents of Japanese Patent Applications No. 2008-150203 filed Jun. 9, 2008 and No. 2008-300296 filed Nov. 26, 2008 are incorporated herein by reference.

What is claimed is:

1. A planetary gear type multi-stage transmission comprising:
an input shaft;
an output shaft;
a first planetary gear set that is arranged in co-axial with the input shaft, the first planetary gear set having a first sun gear, a first ring gear, a plurality of first pinions that engage with the first sun gear and the first ring gear, and a first carrier rotatably supporting the first pinions;
a second planetary gear set having a second sun gear, a second ring gear, a plurality of second pinions that engage with the second sun gear and the second ring gear, and a second carrier rotatably supporting the second pinions;
a first reduction planetary gear set which has an input member, an output member, and a holding member;
a second reduction gear set;
a stationary part; and
a clutch that is capable of locking the second planetary gear set so that the second planetary gear set rotates as one unit, wherein
the input shaft is connected with the first carrier, the input shaft being connectable with the input member and the second ring gear that are connected with each other, wherein
the output shaft and the second carrier are in one of a connected state and a connectable state, the output shaft being connectable with the output member through the second reduction gear set, wherein
the first sun gear and the holding member are connected with each other, the first sun gear and the holding member being holdable to the stationary part, and wherein
the first ring gear and the second sun gear are in one of a connected state and a connectable state.

2. The planetary gear type multi-stage transmission according to claim 1, wherein
the first reduction planetary gear set has a third sun gear, a third ring gear, a plurality of third pinions that engage with the third sun gear and the third ring gear, and a third carrier that rotatably supports the third pinions, and wherein
the third sun gear is the input member, the third carrier being the output member, and the third ring gear being the holding member.

3. The planetary gear type multi-stage transmission according to claim 2, wherein
the second reduction gear set is a planetary gear set that has a fourth sun gear, a fourth ring gear, a plurality of fourth pinions that engage with the fourth sun gear and the fourth ring gear, and a fourth carrier that rotatably supports the fourth pinions, wherein
the fourth sun gear is connected with the output member, the fourth carrier being connected with the output shaft, and the fourth carrier being holdable to the stationary part.

4. The planetary gear type multi-stage transmission according to claim 3, wherein
the input shaft and the output shaft are arranged in parallel to each other, wherein
the first planetary gear set and the first reduction planetary gear set are arranged in co-axial with the input shaft, wherein
the second planetary gear set is arranged at a radially outer side of the first planetary gear set, and wherein
the first ring gear and the second sun gear are formed as one unit.

5. The planetary gear type multi-stage transmission according to claim 4, wherein
the output member and the output shaft are connectable with each other through a reduction gear set.

6. The planetary gear type multi-stage transmission according to claim 2, wherein
the input shaft and the output shaft are arranged in parallel to each other, wherein
the first planetary gear set and the first reduction planetary gear set are arranged in co-axial with the input shaft, wherein
the second planetary gear set is arranged at a radially outer side of the first planetary gear set, and wherein
the first ring gear and the second sun gear are formed as one unit.

7. The planetary gear type multi-stage transmission according to claim 6, wherein
the output member and the output shaft are connectable with each other through a reduction gear set.

8. The planetary gear type multi-stage transmission according to claim 1, wherein
the first reduction planetary gear set has a third sun gear, a third ring gear, a plurality of third outer pinions that engage with the third ring gear, a plurality of third inner pinions that engage with the third outer pinions and the third sun gear, and a third carrier that rotatably supports the third outer pinions and the third inner pinions, and wherein
one of the third sun gear and the third carrier is the input member, the other of the third sun gear and the third carrier being the holding member, and the third ring gear being the output member.

9. The planetary gear type multi-stage transmission according to claim 8, wherein
the second reduction gear set is a planetary gear set that has a fourth sun gear, a fourth ring gear, a plurality of fourth pinions that engage with the fourth sun gear and the fourth ring gear, and a fourth carrier that rotatably supports the fourth pinions, wherein
the fourth sun gear is connected with the output member, the fourth carrier being connected with the output shaft, and the fourth carrier being holdable to the stationary part.

10. The planetary gear type multi-stage transmission according to claim 9, wherein
the input shaft and the output shaft are arranged in parallel to each other, wherein
the first planetary gear set and the first reduction planetary gear set are arranged in co-axial with the input shaft, wherein
the second planetary gear set is arranged at a radially outer side of the first planetary gear set, and wherein
the first ring gear and the second sun gear are formed as one unit.

11. The planetary gear type multi-stage transmission according to claim 10, wherein
the output member and the output shaft are connectable with each other through a reduction gear set.

12. The planetary gear type multi-stage transmission according to claim 8, wherein
the input shaft and the output shaft are arranged in parallel to each other, wherein
the first planetary gear set and the first reduction planetary gear set are arranged in co-axial with the input shaft, wherein
the second planetary gear set is arranged at a radially outer side of the first planetary gear set, and wherein
the first ring gear and the second sun gear are formed as one unit.

13. The planetary gear type multi-stage transmission according to claim 12, wherein
the output member and the output shaft are connectable with each other through a reduction gear set.

14. The planetary gear type multi-stage transmission according to claim 1, wherein
the second reduction gear set is a planetary gear set that has a fourth sun gear, a fourth ring gear, a plurality of fourth pinions that engage with the fourth sun gear and the fourth ring gear, and a fourth carrier that rotatably supports the fourth pinions, wherein
the fourth sun gear is connected with the output member, the fourth carrier being connected with the output shaft, and the fourth carrier being holdable to the stationary part.

15. The planetary gear type multi-stage transmission according to claim 14, wherein
the input shaft and the output shaft are arranged in parallel to each other, wherein
the first planetary gear set and the first reduction planetary gear set are arranged in co-axial with the input shaft, wherein
the second planetary gear set is arranged at a radially outer side of the first planetary gear set, and wherein
the first ring gear and the second sun gear are formed as one unit.

16. The planetary gear type multi-stage transmission according to claim 15, wherein
the output member and the output shaft are connectable with each other through a reduction gear set.

17. The planetary gear type multi-stage transmission according to claim 1, wherein
the input shaft and the output shaft are arranged in parallel to each other, wherein
the first planetary gear set and the first reduction planetary gear set are arranged in co-axial with the input shaft, wherein
the second planetary gear set is arranged at a radially outer side of the first planetary gear set, and wherein
the first ring gear and the second sun gear are formed as one unit.

18. The planetary gear type multi-stage transmission according to claim 17, wherein
the output member and the output shaft are connectable with each other through a reduction gear set.
